(19) United States
(12) Patent Application Publication
(10) Pub. No.: US 2024/0311645 A1
(43) Pub. Date: Sep. 19, 2024

(54) METHODS AND SYSTEMS FOR FEDERATED LEARNING USING FEATURE NORMALIZATION

(71) Applicants: Guojun Zhang, Montreal (CA); Alex Bie, Montreal (CA); Mahdi Beitollahi, Montreal (CA); Xi Chen, Montreal (CA)

(72) Inventors: Guojun Zhang, Montreal (CA); Alex Bie, Montreal (CA); Mahdi Beitollahi, Montreal (CA); Xi Chen, Montreal (CA)

(21) Appl. No.: 18/182,744

(22) Filed: Mar. 13, 2023

(51) Int. Cl. G06N 3/098

(52) U.S. Cl. CPC G06N 3/098

(57) ABSTRACT

Methods and systems for federated learning using feature normalization are disclosed. A client implements a local model including at least: a feature extraction subnetwork to extract a feature vector from input data, a normalization layer to normalize the feature vector, and a final layer to generate a prediction output from the normalized feature vector. The local model is initialized using a set of global parameters received from a central server. The local model is updated using data sampled from a local dataset. Information about a state of the updated local model is transmitted to the central server.

### FIELD

The present disclosure relates to methods and systems for training and deployment of machine learning-based models using federated learning, in particular federated learning using feature normalization.

### BACKGROUND

The usefulness of machine-learning systems typically is dependent on having access to large amounts of data that are used in the training of a machine learning-based model related to a task. There has been interest in how to leverage data from multiple diversified sources, to learn a model related to a task using machine learning.

Federated learning is a machine learning technique in which multiple local data owners (also referred to as users, clients or nodes) participate in training a model (i.e., learning the parameters of a machine learning model) related to a task in a collaborative manner without sharing their local data with each other. Thus, federated learning has been of interest as a solution that allows for training a model related to a task using large amounts of local data (e.g., user-generated data), such as photos, biometric data, etc., without violating data privacy.

A challenge in real-world implementation of federated learning is that the distribution each client's local data can vary significantly. This characteristic of the local data of different clients may sometimes be referred to as non-IID data, where IID means “independent and identically-distributed”, or as data heterogeneity. Data heterogeneity can result in difficulty training a machine learning model using federated learning and/or poor performance of the trained model.

It would be useful to provide a solution for federated learning that is able to help mitigate the challenge of data heterogeneity in clients' local data.

### SUMMARY

In various examples, the present disclosure describes methods and systems for federated learning, which helps to address the problem of data heterogeneity, including the problem of label shift. Examples of the present disclosure describe a neural network architecture for a machine learning model that includes a normalization layer (also referred to as a feature normalization layer, a feature vector normalization layer or a latent representation normalization layer).

Examples of the present disclosure help to address the challenge of data heterogeneity, including label shift, among clients of a federated learning system. This may result in improved performance of the trained global model and/or avoid the need for increased rounds of training. Technical advantages may include reducing the use of resources required for training and/or improved performance of the trained model during inference.

In an example aspect, the present disclosure describes a computing system including a processing unit configured to execute instructions to cause the computing system to: receive, from a central server, a set of global parameters; initialize a local model using the set of global parameters, the local model including at least: a feature extraction subnetwork to extract a feature vector from input data, a normalization layer to normalize the feature vector, and a final layer to generate a prediction output from the normalized feature vector; update the local model using data sampled from a local dataset; and transmit information about a state of the updated local model to the central server.

In an example of the preceding example aspect of the system, the processing unit may be further configured to execute instructions to cause the computing system to: after transmitting the information about the state of the updated local model to the central server, receive, from the central server, a set of trained global parameters; apply the set of trained global parameters to the local model; and deploy the local model after the applying.

In an example of any of the preceding example aspects of the system, the normalization layer may be configured to: receive the feature vector from the feature extraction subnetwork; normalize the feature vector based on a magnitude of the feature vector; and output the normalized feature vector to the final layer.

In an example of any of the preceding example aspects of the system, the normalization layer may be configured to normalize the feature vector by dividing the feature vector by the magnitude of the feature vector.

In an example of any of the preceding example aspects of the system, the normalization layer may be configured to normalize the feature vector by dividing the feature vector by a larger of: the magnitude of the feature vector; or a selected threshold value.

In an example of any of the preceding example aspects of the system, the feature extraction subnetwork may include one or more convolutional layers.

In an example of any of the preceding example aspects of the system, the feature extraction subnetwork may include one or more long short-term memory (LSTM) layers.

In an example of any of the preceding example aspects of the system, the processing unit may be further configured to execute instructions to cause the computing system to: prior to initialization the local model, receive, from the central server, a local model definition defining the local model to include at least the normalization layer.

In another example aspect, the present disclosure describes a method at a computing system, the method including: receiving, from a central server, a set of global parameters; initializing a local model using the set of global parameters, the local model including at least: a feature extraction subnetwork to extract a feature vector from input data, a normalization layer to normalize the feature vector, and a final layer to generate a prediction output from the normalized feature vector; updating the local model using data sampled from a local dataset; and transmitting information about a state of the updated local model to the central server.

In an example of the preceding example aspect of the method, the method may include: after transmitting the information about the state of the updated local model to the central server, receiving, from the central server, a set of trained global parameters; applying the set of trained global parameters to the local model; and deploying the local model after the applying.

In an example of any of the preceding example aspects of the method, the normalization layer may be configured to: receive the feature vector from the feature extraction subnetwork; normalize the feature vector based on a magnitude of the feature vector; and output the normalized feature vector to the final layer.

In an example of any of the preceding example aspects of the method, the normalization layer may be configured to normalize the feature vector by dividing the feature vector by the magnitude of the feature vector.

In an example of any of the preceding example aspects of the method, the normalization layer may be configured to normalize the feature vector by dividing the feature vector by a larger of: the magnitude of the feature vector; or a selected threshold value.

In an example of any of the preceding example aspects of the method, the feature extraction subnetwork may include one or more convolutional layers.

In an example of any of the preceding example aspects of the method, the feature extraction subnetwork may include one or more long short-term memory (LSTM) layers.

In an example of any of the preceding example aspects of the method, the method may include: prior to initialization the local model, receive, from the central server, a local model definition defining the local model to include at least the normalization layer.

In another example aspect, the present disclosure describes a computing system including a processing unit configured to execute instructions to cause the computing system to: transmit, to one or more clients, a model definition for a local model to be implemented at each of the one or more clients, wherein the local model is defined to include at least: a feature extraction subnetwork to extract a feature vector from input data, a normalization layer to normalize the feature vector, and a final layer to generate a prediction output from the normalized feature vector; implement a global model based on the model definition, the global model having a set of global parameters; perform one or more rounds of training by, for each round of training: transmitting a set of global parameters to one or more selected clients of the one or more clients; receiving information about a state of a respective local model from each respective one or more selected clients; aggregating the received information into an aggregated update; and updating the set of global parameters using the aggregated update. The processing unit is configured to execute instructions to further cause the computing system to: after training is terminated, transmit the updated set of global parameters from a last round of training as a set of trained global parameters to all of the one or more clients.

In an example of the preceding example aspect of the system, the normalization layer may be defined to normalize the feature vector by dividing the feature vector by the magnitude of the feature vector.

In an example of any of the preceding example aspects of the system, the normalization layer may be defined to normalize the feature vector by dividing the feature vector by a larger of: the magnitude of the feature vector; or a selected threshold value.

In an example of the preceding example aspect of the system, the feature extraction subnetwork may include one or more convolutional layers or one or more long short-term memory (LSTM) layers.

In another example aspect, the present disclosure describes a non-transitory computer-readable medium having instructions encoded thereon, wherein the instructions are executable by a processing unit of a computing system to cause the computing system to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of a simplified example federated learning system, which may be used to implement examples of the present disclosure;

FIG. 2 is a block diagram of an example computing system, which may be used to implement examples of the present disclosure;

FIG. 3A is a block diagram of an example model including a normalization layer, in accordance with examples of the present disclosure;

FIG. 3B illustrates an example round of training in a federated learning system, in accordance with examples of the present disclosure;

FIG. 4 is a flowchart illustrating an example method performed by a client in a federated learning system, in accordance with examples of the present disclosure; and

FIG. 5 is a flowchart illustrating an example method performed by a central server in a federated learning system, in accordance with examples of the present disclosure.

Similar reference numerals may have been used in different figures to denote similar components.

### DETAILED DESCRIPTION

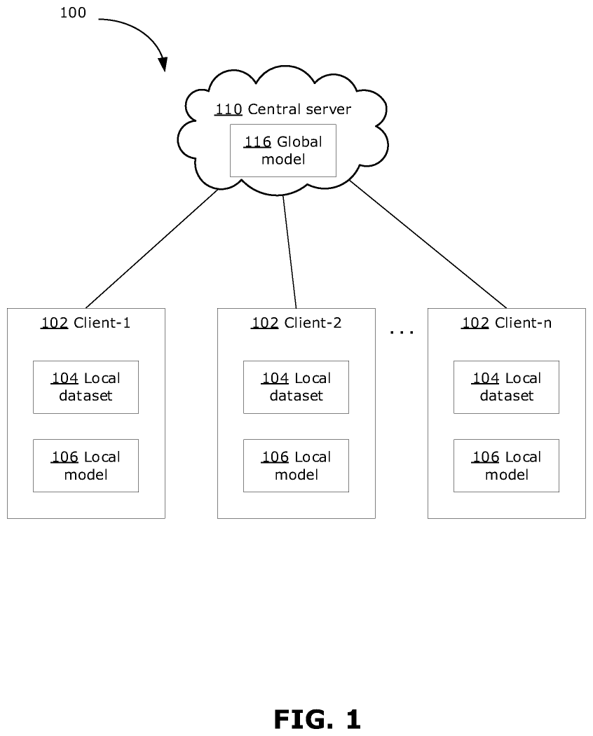

In example embodiments disclosed herein, methods and systems for training a machine learning model related to a task using federated learning are described in which the machine learning model has a model architecture that includes at least one normalization layer configured to normalize latent representations (also referred to as feature vectors). Examples of the present disclosure may enable a machine learning model to be collaboratively trained using local data from multiple client, where the local data of different clients may exhibit data heterogeneity (including label shift). Examples of the present disclosure may be implemented in various federated learning systems and may be adapted for various types of machine learning models. To assist in understanding the present disclosure, FIG. 1 is first discussed.

FIG. 1 illustrates an example federated learning system 100 that may be used to implement examples of federated learning using normalization of feature vectors (also referred to as latent representation normalization (LRN)), as disclosed herein. The federated learning system 100 has been simplified in this example for ease of understanding; generally, there may be more entities and components in the federated learning system 100 than that shown in FIG. 1.

The federated learning system 100 includes a plurality of clients 102 (client-1 102 to client-n 102, generally referred to as client 102), each of which collect and store respective sets of local data (also referred to as local datasets 104). It should be understood that clients 102 may alternatively be referred to as user devices, data owners, client devices, edge devices, nodes, terminals, consumer devices, or electronic devices, among other possibilities. That is, the term “client” is not intended to limit implementation in a particular type of device or in a particular context. Each client 102 communicates with a central server 110, which may also be referred to as a central node. Optionally, a client 102 may also communicate directly with another client 102. Communications between a client 102 and the central server 110 (and optionally between a client 102 and another client 102) may be via any suitable network (e.g., the Internet, a peer-to-peer (P2P) network, a wide area network (WAN) and/or a local area network (LAN)), and may include wireless or wired communications.

Although referred to in the singular, it should be understood that the central server 110 may be implemented using one or multiple servers. For example, the central server 110 may be implemented as a server, a server cluster, a distributed computing system, a virtual machine, or a container (also referred to as a docker container or a docker) running on an infrastructure of a datacenter, or infrastructure (e.g., virtual machines) provided as a service by a cloud service provider, among other possibilities. Generally, the central server 110 may be implemented using any suitable combination of hardware and software, and may be embodied as a single physical apparatus (e.g., a server) or as a plurality of physical apparatuses (e.g., multiple servers sharing pooled resources such as in the case of a cloud service provider). As such, the central server 110 may also generally be referred to as a computing system or processing system.

Each client 102 may independently be an end user device, a network device, a private network, or other singular or plural entity that stores a local dataset 104 (which may be considered private data) and a local model 106. In the case where a client 102 is an end user device, the client 102 may be or may include such devices as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicles, or consumer electronics device, among other possibilities. In the case where a client 102 is a network device, the client 102 may be or may include a base station (BS) (erg eNodeB or gNodeB), router, access point (AP), personal basic service set (PBSS) coordinate point (PCP), among other possibilities. In the case where a client 102 is a private network, the client 102 may be or may include a private network of an institute (e.g., a hospital or financial institute), a retailer or retail platform, a company's intranet, etc.

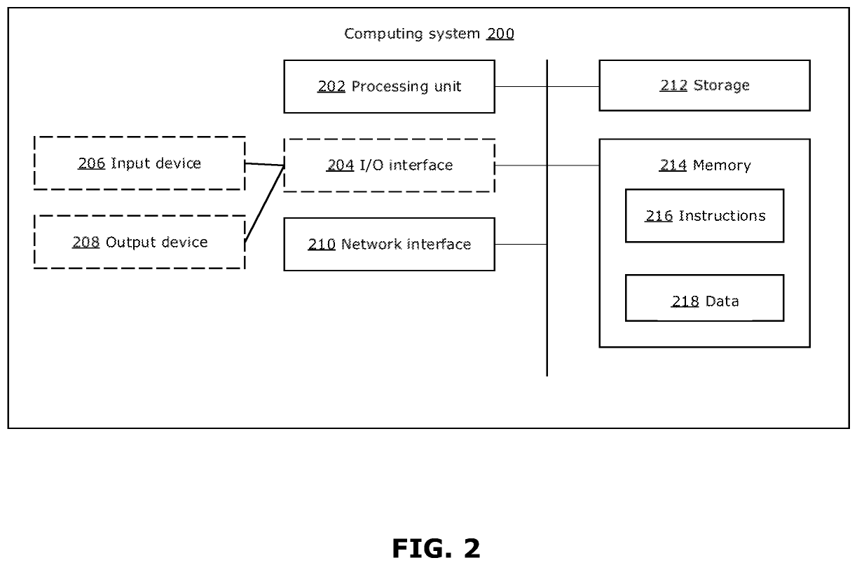

FIG. 2 is a block diagram illustrating a simplified example computing system 200, which may be used to implement the central server 110 or to implement any of the clients 102. Other example computing systems suitable for implementing embodiments described in the present disclosure may be used, which may include components different from those discussed below. Although FIG. 2 shows a single instance of each component, there may be multiple instances of each component in the computing system 200.

The computing system 200 may include one or more processing units 202, such as a processor, a microprocessor, a digital signal processor, an application-specific integrated circuit (ASIC), a field-programmable gate array (FPGA), a dedicated logic circuitry, a dedicated artificial intelligence processor unit, a tensor processing unit, a neural processing unit, a hardware accelerator, or combinations thereof. Each processing unit 202 may include one or more processing cores.

The computing system 200 may also include one or more optional input/output (I/O) interfaces 204, which may enable interfacing with one or more optional input devices 206 and/or optional output devices 208. In the example shown, the input device(s) 206 (e.g., a keyboard, a mouse, a microphone, a touchscreen, and/or a keypad) and output device(s) 208 (e.g., a display, a speaker and/or a printer) are shown as optional components of the computing system 200. In some examples, one or more input device(s) 206 and/or output device(s) 208 may be external to the computing system 200. In other example embodiments, there may not be any input device(s) 206 and output device(s) 208, in which case the I/O interface(s) 204 may not be needed.

The computing system 200 may include one or more network interfaces 210 for wired or wireless communication (e.g., with other entities of the federated learning system 100). For example, if the computing system 200 is used to implement the central server 110, the network interface(s) 210 may be used for wired or wireless communication with the clients 102; if the computing system 200 is used to implement a client 102, the network interface(s) 210 may be used for wired or wireless communication with the central server 110 (and optionally with one or more other clients 102). The network interface(s) 210 may include wired links (e.g., Ethernet cable) and/or wireless links (e.g., one or more antennas) for intra-network and/or inter-network communications.

The computing system 200 may also include one or more storage units 212, which may include a mass storage unit such as a solid state drive, a hard disk drive, a magnetic disk drive and/or an optical disk drive.

The computing system 200 may include one or more memories 214, which may include a volatile or non-volatile memory (e.g., a flash memory, a random access memory (RAM), and/or a read-only memory (ROM)). The non-transitory memory(ies) 214 may store instructions 216 for execution by the processing unit(s) 202, such as to carry out example embodiments described in the present disclosure. The memory(ies) 214 may include other software instructions, such as for implementing an operating system and other applications/functions. In some example embodiments, the memory(ies) 214 may include software instructions 216 for execution by the processing unit(s) 202 to implement a federated learning algorithm, as discussed further below. The memory(ies) 214 may also store data 218, such as machine learning model parameters (e.g., values of weights in the case where a model is implemented using a neural network).

In some example embodiments, the computing system 200 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. It should be understood that, unless explicitly stated otherwise, references to computer-readable medium in the present disclosure is intended to exclude transitory computer readable medium.

Reference is again made to FIG. 1. Each client 102 stores (or has access to) a respective local dataset 104 (e.g., stored as data in the memory of the client 102, or accessible from a private database). The local dataset 104 of each client 102 may be unique and distinctive from the local dataset 104 of each other client 102.

In the case where a client 102 is an end user device, the local dataset 104 may include data that is collected or generated in the course of real-life use by user(s) of the client 102 (e.g., captured images/videos, captured sensor data, captured tracking data, etc.). In the case where a client 102 is a network device, the local dataset 104 may include data that is collected from other end user devices that are associated with or served by the client 102 (e.g., network usage data, traffic data, etc.). In general, the local dataset 104 is considered to be private or proprietary data of the client 102 (e.g., restricted to be used only within a private network if the client 102 is a private network, or is considered to be personal data if the client 102 is an end user device), and it is generally desirable to ensure privacy and security of the local dataset 104 at each client 102.

Federated learning is a machine learning technique that enables the clients 102 to participate in learning a model related to a task (e.g., a global model or a collaborative model) without having to share their local dataset 104 with the central server 110 or with other clients 102. In the example shown, a global model 116 is stored at the central server 110, the parameters of which are learned via collaboration with the clients 102.

An approach that may be used in federated learning is commonly referred to as “FederatedAveraging” or FedAvg (e.g., as described by McMahan et al. “Communication-efficient learning of deep networks from decentralized data” AISTATS, 2017). An example of learning the global model 116 using FedAvg is now discussed, although it should be understood that the present disclosure is not limited to the FedAvg approach. Examples of the present disclosure may be implemented using various federated learning algorithms that do not directly change the global model 116, such as FedAvg, FedProx (e.g., as described by Li et al. “Federated optimization in heterogeneous networks” Proceedings of Machine Learning and Systems, 2:429-450, 2020), SCAFFOLD (e.g., as described by Karimireddy et al. “SCAFFOLD: Stochastic controlled averaging for federated learning” International Conference on Machine Learning, pp. 5132-5143, 2020), FedYogi (federated learning using a YOGI optimizer, for example described by Zaheer et al. “Adaptive methods for nonconvex optimization” Advances in Neural Information Processing Systems, pp. 9815-9825, 2018), or FedRS (e.g., described by Li et al. “FedRS: Federated learning with restricted softmax for label distribution non-IID data”, KDD '21: Proceedings of the 27^{th} ACM SIGKDD Conference on Knowledge Discovery & Data Mining, pp. 995-1005, 2021), among others.

A round of training (also referred to as a communication round) may begin with the central server 110 sending the parameters of the global model 11 (referred to as the global parameters) to selected clients 102. The central server 110 may select one, some or all of the clients 102 in the federated learning system 100 as participants in each round of training. The client(s) 102 selected for each round of training may differ from round to round.

After receiving a copy of the global parameters, each client 102 uses the received global parameters to update its own local model 106. The client 102 then applies the local model 106 to its own local dataset 104 to compute an update for the local model 106. For example, the client 102 may compute a loss function between output generated by the local model 106 (after updating using the received global parameters) and the ground-truth label(s) in its local dataset 104. The client 102 may then use the loss function in a stochastic gradient descent (SGD) algorithm to update the local model 106.

Information about the updated state of the local model 106 may be sent by the client 106 back to the central server 110. For example, the updated state of the local model 106 may be communicated in the form of a set of updated local parameters.

The central server 110 receives the update information from each client 102 that was selected for the round of training and aggregates the received information to update the parameters of the global model 116. In FedAvg, the update to the global model 116 is performed by averaging the update information (e.g., a weighted average of the updated local parameters) and adding the average to the parameters of the global model 116. After the global parameters have been updated, the round of training is complete.

Multiple rounds of training may take place (with possibly different clients 102 participating in each round of training) until a termination condition is met (e.g., a maximum number of rounds has been reached, or the global parameters have converged). After training has ended, each client 102 may use the global parameters to execute its own local model 106 to generate predictions.

There are some challenges with deployment of federated learning in real-world scenarios. In real-world scenarios, different clients 102 may be associated with different and diverse environments and the statistical distribution of data in the local datasets 104 can vary drastically, resulting in data heterogeneity. Data heterogeneity means that statistical distribution of data is different between different local datasets 104. A type of data heterogeneity is referred to as label shift, which may occur when different local datasets 104 have different class distribution. For example, if the clients 102 are different end user devices, the local datasets 104 may reflect each user's collection of images that are captured in the user's day-to-day activities. Thus, it can be expected that each local dataset 104 has a respective unique label distribution, with different numbers of samples for different classes. For example, one local dataset 104 may include many images of cats and no images of horses, whereas another local dataset 104 may include many images of horses and no images of cats.

In general, data heterogeneity can result in reduced performance of the trained global model 116 and/or can result in increased training required to reach model convergence. Reduced performance of the trained global model 116 is a technical problem that detracts from the purported benefits of federated learning (such as the benefit of collaboratively learning a global model 116 from a large amount of data). The need for increased training is also a technical problem because each round of training requires use of resources (e.g., communication bandwidth, processing power, memory resources, etc.), thus having to perform a large amount of training can be resource-intensive and inefficient.

Some existing attempts to address the challenge of data heterogeneity in federated learning include approaches that aim to regulate the deviation of local models 106 during local training at each client 102 and approaches that aim to improve the aggregation method at the central server 110. Approaches that add proximity terms to restrain the local model 106 from drifting away from the global model 116 may limit the ability of clients 102 to introduce new information to the global model 116 at each training round. Another approach to regulate the drift is to limit the number of local steps performed by each client 102 (e.g., performing only a single step would be equivalent to centralized training); however, this approach hinders the convergence rate of the global model 116 and thus requires many more training rounds to achieve a desired level performance which may not be suitable for real-world implementation (e.g., due to increased communication overhead and convergence time). Other approaches that aim to improve the aggregation method at the central server 110 do not directly address the problem of data heterogeneity and may require access to an additional proxy or public dataset which may not be available.

In various examples, the present disclosure describes a neural architecture for the local model 106, which may help to mitigate the challenge of label shift in federated learning. In particular, the neural architecture disclosed herein introduces a feature normalization layer in the local model 106.

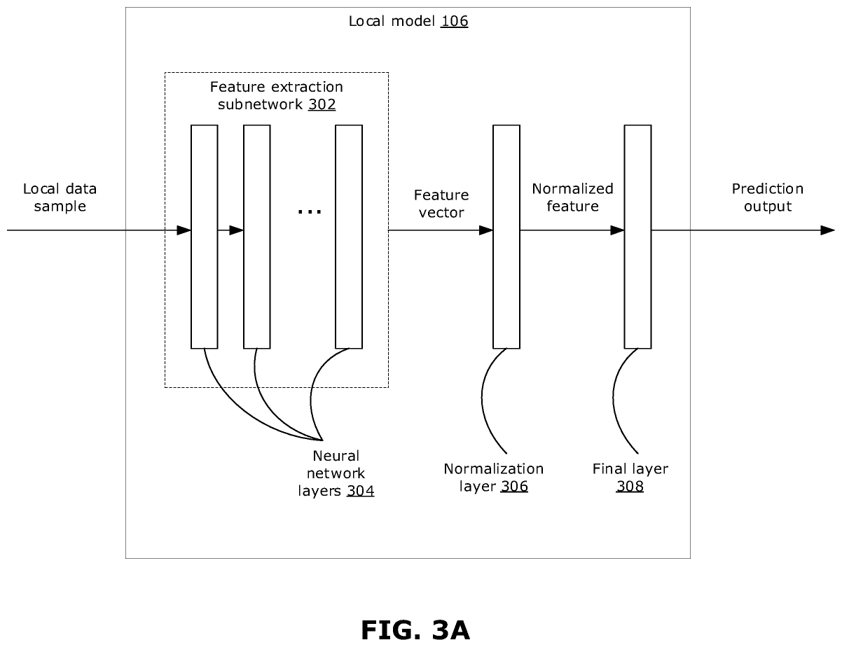

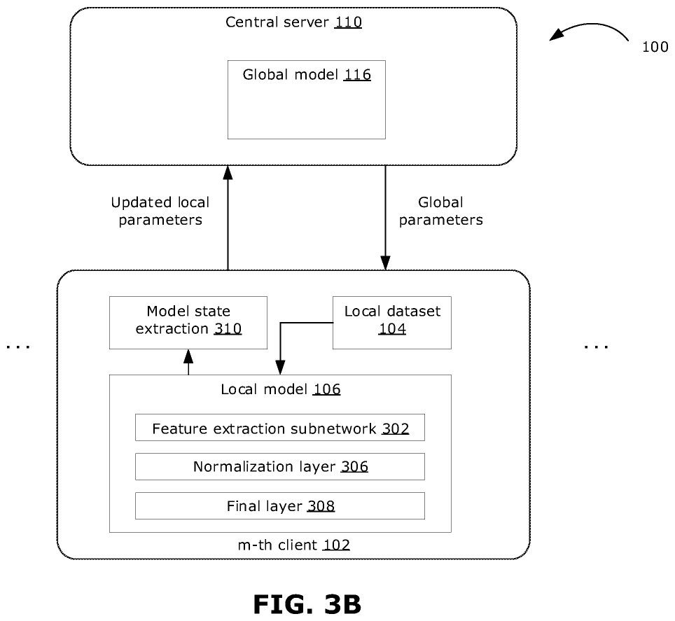

FIG. 3A is a block diagram illustrating details of an example local model 106 in accordance with examples of the present disclosure. It should be understood that although FIG. 3A illustrates the local model 106 being implemented using certain blocks and layers, this is not intended to be limiting. Further, it should be understood that the blocks and layers shown in FIG. 3A may be implemented as software (e.g., by the processing unit of the client 102 executing instructions to perform the operations represented by the blocks and layers).

The local model 106 receives a data sample from the local dataset 104 and processes the data sample through a sequence of neural network layers to generate a prediction output. For example, the input data sample may be an image (e.g., a 2D RGB image) and the prediction output may be a predicted class of an object in the image.

The local model 106 includes a feature extraction subnetwork 302, which includes one or more neural network layers 304, that extracts a feature vector from the input data sample. The particular neural network layers 304 of the feature extraction subnetwork 302 may be dependent on the task to be performed by the local model 106. For example, if the local model 106 is designed to perform an image processing task then the neural network layers 304 may include one or more convolutional layers. The feature vector is received by a normalization layer 306. The normalization layer 306 normalizes the feature vector by the magnitude of the feature vector (the normalization layer 306 may also be referred to as a feature normalization layer, a latent representation normalization layer or a feature vector normalization layer). The feature vector normalization that is performed by the normalization layer 306 may be represented as follows:

$$norm ( {g}_{θ} ) = \frac{{g}_{θ}}{‖ {g}_{θ} ‖}$$

where g_{θ} denotes the feature vector extracted by the feature extraction subnetwork 302, norm(g_{θ}) is the output of the normalization layer 306, and ∥g_{θ}∥ is the magnitude of the feature vector.

It should be appreciated that the normalization layer 306 normalizes the feature vector by the magnitude of the feature vector in particular and should not be confused with other normalization techniques (such as normalizing by variance). Normalization of the feature vector using the normalization layer 306 (e.g., using the normalization operation described above) may help to control the divergence of the feature norm among multiple clients 102, which would otherwise occur due to differences in data distribution in the different local datasets 104. The divergence of feature norm among clients 102, which may arise in conventional federated learning approaches, has been found to lead to poor performance and/or poor convergence of the global model 116.

The normalized feature may then be processed by a final layer 308 of the local model 106. For example, if the local model 106 is designed to perform a class prediction task (i.e., a classification task), the final layer 308 may be a classification layer that compares the normalized feature with different class vectors to generate a predicted class label as the prediction output. Depending on the intended task of the local model 106, the final layer 308 may perform different operations.

In some examples, the normalization performed by the normalization layer 306 may be modified to help improve stability of the local model 106. The normalization may be modified to include a selected threshold value that may be used in place of the magnitude of the feature vector when the magnitude of the feature vector is too small. The normalization layer 306 may perform a modified feature vector normalization as follows:

$$norm ( {g}_{θ} ) = \frac{{g}_{θ}}{max ( ‖ {g}_{θ} ‖ , ϵ )}$$

where ∈ denotes a selected threshold value. The selected threshold value may be selected to be some small value (e.g., in the range of 10⁻⁶ to 10⁻¹²). The selected threshold value may be selected based on, for example, empirical testing. In this example, the selected threshold value is used instead of the magnitude of the feature vector to normalize the feature vector if the magnitude of the feature vector is smaller than the selected threshold value. This may help avoid instability that may occur when the magnitude of the feature vector is very small (which would otherwise cause the normalized feature to be large).

It should be understood that the normalization layer 306 may be incorporated into various conventional neural network architectures to arrive at the local model 106 as disclosed. For example, a conventional convolutional neural network (CNN) may use convolutional layers, pooling layers and linear layers. The normalization layer 306 may be added as a penultimate layer to normalize the feature vector (extracted by preceding convolutional layers and pooling layers, for example) prior to generating a prediction output using a final layer. In another example, deep residual networks (e.g., ResNet) such as those commonly used for computer vision tasks may be adapted by the incorporation of the normalization layer 306. Conventional ResNet architecture may involve batch normalization. The batch normalization layer in ResNet may be replaced with the normalization layer 306 as disclosed herein. In another example, a long short-term memory (LSTM) neural network architecture is commonly used for processing text data and natural language processing. The normalization layer 306 may be incorporated into the LSTM architecture, for example as a penultimate layer.

By introducing normalization of the feature vector in the local model 106 implemented by each client 102, examples disclosed herein may help to mitigate the challenge of data heterogeneity (including label shift) in federated learning.

It should be noted that because the global model 116 should correspond to the local model 106 at each client 102 (that is, the global model 116 and the local model 106 should have the same neural network architecture), the implementation of the normalization layer 306 in the local model 106 should be reflected in a corresponding normalization layer in the global model 116.

FIG. 3B illustrates an example of how feature vector normalization (e.g., using the local model 106 with normalization layer 306) may be implemented in a federated learning system 100. For simplicity, only one client 102 is shown, however it should be understood that there may be any number of clients 102 in the system 100 (e.g., there may be 1 to n clients 102 as shown in FIG. 1). Further, there may be any number of selected clients 102 that are selected to participate in each round of training.

For generality, the client 102 shown in FIG. 3B may be denoted as the m-th client 102. The m-th client 102 may be provided with a definition of the local model 106 to be implemented. For example, each client 102 may be provided a definition of the local model 106 from the central server 110 when the client 102 joints the federated learning system 100 (e.g., when the client 102 registers itself with the central server 110 to collaborate in the learning of the global model 116). The definition of the local model 106 may, for example, be provided to the client 102 as a set of definitions for the neural network layers (e.g., defining the number and type of inputs and outputs). Each client 102 is provided with the same definition such that each client 102 implements the local model 106 using the same neural network architecture (having the same feature extraction subnetwork 302, normalization layer 306 and final layer 308). The global model 116 implemented at the central server 110 also has the same model definition.

A round of training is described where the m-th client 102 is selected (e.g., by the central server 110) to participate in the round. The round of training may begin with the central server 110 communicating the global parameters of the current global model 116 to each client 102. Each client 102 may then apply the global parameters to the respective local model 106 (e.g., initializing the local model 106 by replacing the values of the local parameters with the received global parameters). Data samples from the local dataset 104 are processed using the local model 106 (using the feature extraction subnetwork 302, normalization layer 306 and final layer 308 as described above) and the prediction output is compared with the ground-truth label to update the local model 106 (e.g., using a suitable machine learning algorithm such as gradient descent). The state of the local model 106 (i.e., the state of the local model 106 after the update) is extracted, for example by a model state extraction module 310. For example, the set of updated local parameters (i.e., the updated values of the parameters of the local model 106) may be extracted by the model state extraction module 310, and communicated by the m-th client 102 to the central server 110. It should be understood that information about the state of the local model 106 may, instead of the local parameters, be represented in other ways, for example the state of the local model 106 may be represented by the difference between the values of the updated local parameters and the prior (i.e., pre-update) values of the local parameters. The central server 110, after receiving information about the state of the local model 106 from each client 102 participating in the round of training, may aggregate the received information using any suitable federated learning technique (e.g., by weighted average). The central server 110 then updates the global model 116 using the aggregated information. The next round of training may then begin with the central server 110 communicating the updated global parameters to each client 102 and each client 102 using the global parameters to initialize the parameters of the local model 106.

The rounds of training may continue (and different clients 102 may be selected by the central server 110 to participate in different rounds of training) until a termination condition is met (e.g., a maximum number of rounds has been performed; or the global model 116 has converged).

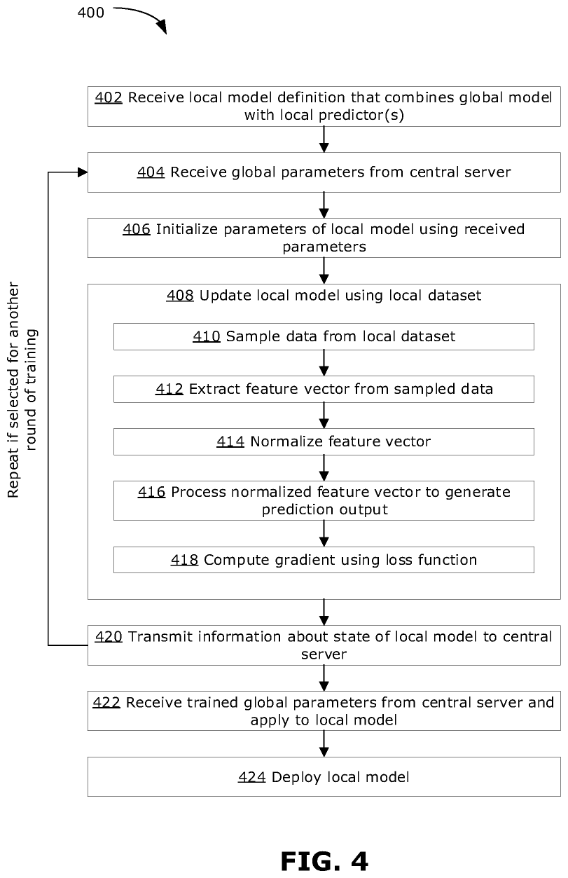

FIG. 4 is a flowchart showing an example method 400 which may be performed by a client 102 in the federated learning system 100, where the local model 106 includes a normalization layer 306. The method 400 may be performed by the client 102 in parallel with the method 500 performed by the central server 110. In other words, the method 400 may represent operation of the federated learning system 100 from the point of view of one client 102. Multiple clients 102 may each perform the method 400 in the federated learning system 100. The computing system 200 of FIG. 2 may be an embodiment of the client 102 and the method 400 may be performed using a processing unit 202 of the client 102 executing instructions (e.g., instructions 216 stored in memory 214), for example.

At 402 the client 102 receives a local model definition, which the client 102 uses to define the local model 106. The local model definition defines the neural network architecture of the local model 106, and the local model 106 may be defined to have the same architecture as the global model 116 at the central server 110. The local model definition defines the local model 106 to include a feature extraction subnetwork 302 (which may include one or more neural network layers 304, the design of the neural network layer(s) 304 being dependent on the task to be performed by the local model 106) that is configured to extract a feature vector from a data sample. The local model definition also defines the local model 106 to include a normalization layer 306 that normalizes the feature vector based on the magnitude of the feature vector. In some examples, the normalization layer 306 normalizes the feature vector using the magnitude of the feature vector. In other examples, the normalization layer 306 normalizes the feature vector using the magnitude of the feature vector if the magnitude of the feature vector is greater than a selected threshold value, otherwise the selected threshold value is used to normalize the feature vector. The local model definition also defines the local model to include a final layer 308 that processes the normalized feature vector to generate a prediction output (the design of the final layer 308 is dependent on the prediction task to be performed by the local model 106).

Step 402 may occur any time prior to the client 102 being a participant in a round of collaborative training. For example, step 402 may occur at the time that the client 102 is registered with the central server 110, or may occur just prior to the first round of training in which the client 102 has been selected (by the central server 110) as a participant.

The client 102 may participate in a round of training with the central server 110 and other participating clients 102 by performing steps 404 to 410.

At 404, the client 102 receives a set of global parameters from the central server 110. The global parameters received at step 404 may be the parameters learned from a prior round of training or, if this is the first round of training, may be the initial (e.g., randomly initialized) parameters.

At 406, the client 102 uses the received global parameters to initialize the parameters of its local model 106. For example, the client 102 may use the received global parameters to replace the values of the parameters of its local model 106.

At 408, the local model 106 is updated by the client 102 using the local dataset 104. Updating the local model 106 may involve operations of sampling from the local dataset 104, processing the sampled data using the local model 106 (which may include processing the sampled data using the feature extraction subnetwork 302, normalization layer 306 and final layer 308), computing a loss function and updating the local model 106 using a gradient computed from the loss function. In particular, performing step 408 may involve performing steps 410-418.

At 410, data is sampled from the local dataset 104. The data may be sampled from the local dataset 104 as a batch in some examples. For simplicity, a single data sample is referred to in the following steps, however it should be understood that a batch of data may be sampled and used for the local model update. The sampled data is processed using the local model 106.

At 412, a feature vector is extracted from the sampled data, for example by processing the sampled data using the neural network layer(s) 304 of the feature extraction subnetwork 302. The feature vector is a latent representation of the sampled data that is relevant to the prediction task to be performed by the local model 106.

At 414, the feature vector is normalized, for example by processing the feature vector using the normalization layer 306. The feature vector is normalized based on the magnitude of the feature vector. For example, the feature vector may be normalized by dividing by the magnitude of the feature vector. In another example, the feature vector may be normalized by dividing by the larger of: the magnitude of the feature vector or a selected threshold value (which may be a small empirically selected value, such as in the range of 10⁻⁶ to 10⁻¹²).

At 416, the normalized feature vector is processed (e.g., using final layer 308) to generate a prediction output. For example, if the local model 106 is designed to perform an image classification task, then the data sample may be a 2D RGB image and the prediction output may be a predicted class label for an object in the image.

At 418, a gradient (which is used to update the local model 106) is computed using a loss function. The loss function may represent the error between the prediction output generated by the local model 106 (at step 416) and the ground-truth label of the sampled data. The gradient may then be computed using a gradient descent algorithm, for example, based on the loss function. If the sampled data was sampled as a batch, a stochastic batch gradient may be computed from the gradients computed over the batch.

At 420, information about the updated state of the local model 106 (e.g., in the form of the updated parameters of the local model 106, or in the form of the difference in value between the updated parameters and the parameters prior to the update) is transmitted to the central server 110.

Steps 404 to 420 (which form one round of training) may be repeated for one or more rounds of training, if the client 102 is selected by the central server 110 for subsequent round(s) of training. The training may continue until termination by the central server 110 (e.g., when the central server 110 determines that a termination condition is met). When training is complete, the method 400 proceeds to step 422.

At 422, the client 102 receives, from the central server 110, a set of trained global parameters. The trained global parameters may be the parameters of the global model 116, computed by the central server 110, from the last round of training prior to termination. The client 102 may apply the trained global parameters to the local model 106. For example, the client 102 may replace the values of the parameters of the local model 106 using the values of the trained global parameters.

The local model 106, with the trained global parameters, is now considered to be trained and can be deployed for inference. The client 102 may remain in communication with the central server 110, or may no longer communicate with the central server 110 (and may dismantle any connection that was established with the central server 110).

At 424, the local model 106 is deployed by the client 102. That is, the client 102 may execute the local model 106 to generate predictions.

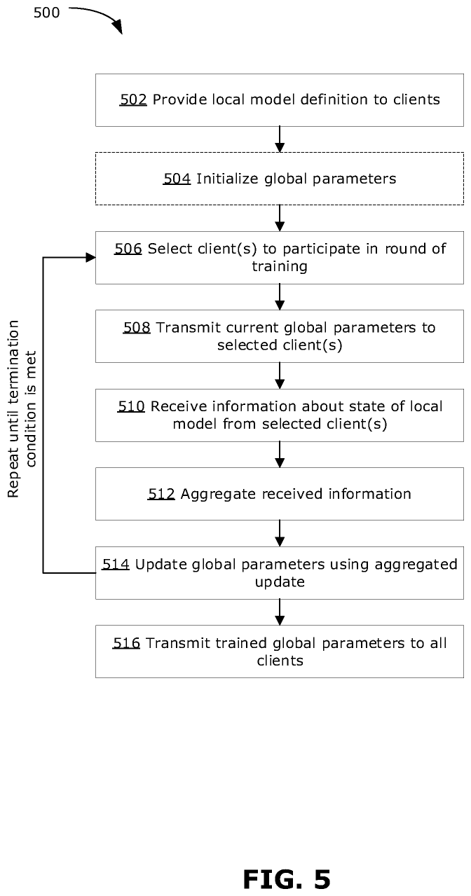

FIG. 5 is a flowchart showing an example method 500 which may be performed by the central server 110. The method 500 may be performed by the central server 110 in parallel with the method 400 performed by the client 102. In other words, the method 500 may represent operation of the federated learning system 100 from the point of view of the central server 110. The computing system 200 of FIG. 2 may be an embodiment of the central server 110 and the method 500 may be performed using a processing unit 202 of the client central server 110 executing instructions (e.g., instructions 216 stored in memory 214), for example.

At 502, the definition of the local model is provided by the central server 110 to each client 102 participating in the collaborative learning of the global model 116. As previously mentioned, the local model definition is used by each client 102 to define its respective local model 106. In particular, the local model definition defines the local model 106 to include a normalization layer 306 for normalization of a feature vector extracted from a data sample, as described above. The central server 110 may provide the local model definition to each client 102 at the time that client 102 registers with the central server 110 for collaborating in the federated learning system 100, for example.

Optionally, at 504, the global parameters (i.e., the parameters of the global model 116) are initialized. The global parameters may be randomly initialized or may be initialized based on parameter values learned from some pre-training phase. In some examples, initialization may not be required (e.g., if the global parameters have been previously trained).

The central server 110 may carry out one or more rounds of training, where each round of training may be performed using steps 506 to 514.

At 506, one or more clients 102 are selected to participate in a current round of training. The client(s) 102 may be selected at random, or based on a predefined criteria, such as selecting only client(s) 102 that did not participate in an immediately previous round of training, etc. The client(s) 102 may be selected such that a certain predefined number (e.g., 1000 clients 102) or a certain predefined fraction of clients 102 (e.g., 10% of all clients 102) participate in the current round of training.

At 508, the current set of global parameters (i.e., the current values of the parameters of the global model 116, such as the current values of the weights of the neural network used to implement the global model 116) are transmitted to the selected client(s) 102. The current global parameters may be the parameters resulting from a previous round of training. If this is the first round of training, the current global parameters may be the initialized values.

At 510, information about the state of each local model 106 is received from each of the selected client(s) 102. For example, each client 102 may compute a respective local model update and communicate information about the respective updated model state (e.g., in the form of a set of local parameters or in the form of a difference between the values of the parameters after the updating and before the updating) to the central server 110, as described above.

At 512, the received information about the state of the local models are aggregated into an aggregated update. Any suitable federated learning approach (e.g., FedAvg) may be used to aggregate the received information, such by computing a weighted average of the received sets of local parameters or by computing a weighted average of the received differences in parameter values.

At 514, the aggregated update is used to update the global parameters.

Steps 506 to 514 may be repeated for each round of training, until a termination condition is met (e.g., the maximum number of rounds of training has been reached, or the global parameters have converged).

When the termination condition has been met, the central server 110 terminates the training phase. The global parameters are considered to be trained and can be used in the inference phase.

At 516, the central server 110 transmits the set of trained global parameters (i.e., the global parameters resulting from the last round of training prior to termination) to all clients 102 of the federated learning system 100. Each client 102 may then use the trained global parameters in their respective local model 106, and deploy the local model 106 to generate predictions.

The method 400 and the method 500 may be performed together (the method 400 being performed by client(s) 102 and the method 500 being performed by the central server 110) in the federated learning system 100.

In some examples, the central server 110 may perform additional operations (not shown in FIG. 5) to ensure that the client 102 is using an approved or authorized local model 106. This may help to ensure that the client 102 is approved or authorized to participate in the federated learning system 100. For example, the model definition provided to each client 102 at the time of registration with the central server 110 may include a watermarking algorithm. For example, the normalization layer 306 may, in addition to performing normalization of the feature vector, embed a digital watermark in the normalized feature vector, which may be detectable when examined. The central server 110 may perform operations to check for the presence of the watermark in the information communicated from each client 102. If the expected watermark is not found in the information from a particular client 102 then the central server 110 may exclude that particular client 102 from further participation in the federated learning system 100 (e.g., exclude that particular client 102 from further rounds of training and cease sending any global parameters to that particular client 102).

It should be understood that examples of the present disclosure may be applicable to federated learning in different scenarios and for learning a model to perform various tasks. Although image processing and classification has been described in some examples, this is not intended to be limiting. The present disclosure may be useful for collaborative learning of a model for text prediction tasks, recommendation tasks (e.g., image recommendation, video recommendation, etc.), voice assistant or chatbot applications, as well as network-related applications (e.g., traffic engineering models, etc.).

Examples of the present disclosure may be compatible with some approaches for privacy protection. For example, differential privacy is an existing approach for ensuring data privacy and has been explored as a way to strengthen privacy protection in federated learning.

In various examples, the present disclosure have described methods and systems that help to address the challenge of data heterogeneity, including label shift, among different clients in a federated learning system. Examples of the present disclosure may be implemented in existing federated learning systems. Various neural network architectures may be adapted to include feature vector normalization, as disclosed herein.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute example embodiments of the methods disclosed herein. The machine-executable instructions may be in the form of code sequences, configuration information, or other data, which, when executed, cause a machine (e.g., a processor or other processing device) to perform steps in a method according to example embodiments of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system comprising:
a processing unit configured to execute instructions to cause the computing system to:
receive, from a central server, a set of global parameters;
initialize a local model using the set of global parameters, the local model including at least: a feature extraction subnetwork to extract a feature vector from input data, a normalization layer to normalize the feature vector, and a final layer to generate a prediction output from the normalized feature vector;
update the local model using data sampled from a local dataset; and
transmit information about a state of the updated local model to the central server.

2. The computing system of claim 1, wherein the processing unit is further configured to execute instructions to cause the computing system to:
after transmitting the information about the state of the updated local model to the central server, receive, from the central server, a set of trained global parameters;
apply the set of trained global parameters to the local model; and
deploy the local model after the applying.

3. The computing system of claim 1, wherein the normalization layer is configured to:
receive the feature vector from the feature extraction subnetwork;
normalize the feature vector based on a magnitude of the feature vector; and
output the normalized feature vector to the final layer.

4. The computing system of claim 3, wherein the normalization layer is configured to normalize the feature vector by dividing the feature vector by the magnitude of the feature vector.

5. The computing system of claim 3, wherein the normalization layer is configured to normalize the feature vector by dividing the feature vector by a larger of:
the magnitude of the feature vector; or
a selected threshold value.

6. The computing system of claim 1, wherein the feature extraction subnetwork includes one or more convolutional layers.

7. The computing system of claim 1, wherein the feature extraction subnetwork includes one or more long short-term memory (LSTM) layers.

8. The computing system of claim 1, wherein the processing unit is further configured to execute instructions to cause the computing system to:
prior to initialization the local model, receive, from the central server, a local model definition defining the local model to include at least the normalization layer.

9. A method at a computing system, the method comprising:
receiving, from a central server, a set of global parameters;
initializing a local model using the set of global parameters, the local model including at least: a feature extraction subnetwork to extract a feature vector from input data, a normalization layer to normalize the feature vector, and a final layer to generate a prediction output from the normalized feature vector;
updating the local model using data sampled from a local dataset; and
transmitting information about a state of the updated local model to the central server.

10. The method of claim 9, further comprising:
after transmitting the information about the state of the updated local model to the central server, receiving, from the central server, a set of trained global parameters;
applying the set of trained global parameters to the local model; and
deploying the local model after the applying.

11. The method of claim 9, wherein the normalization layer is configured to:
receive the feature vector from the feature extraction subnetwork;
normalize the feature vector based on a magnitude of the feature vector; and
output the normalized feature vector to the final layer.

12. The method of claim 11, wherein the normalization layer is configured to normalize the feature vector by dividing the feature vector by the magnitude of the feature vector.

13. The method of claim 11, wherein the normalization layer is configured to normalize the feature vector by dividing the feature vector by a larger of:
the magnitude of the feature vector; or
a selected threshold value.

14. The method of claim 9, wherein the feature extraction subnetwork includes one or more convolutional layers.

15. The method of claim 9, wherein the feature extraction subnetwork includes one or more long short-term memory (LSTM) layers.

16. The method of claim 9, further comprising:
prior to initialization the local model, receive, from the central server, a local model definition defining the local model to include at least the normalization layer.

17. A computing system comprising:
a processing unit configured to execute instructions to cause the computing system to:
transmit, to one or more clients, a model definition for a local model to be implemented at each of the one or more clients, wherein the local model is defined to include at least: a feature extraction subnetwork to extract a feature vector from input data, a normalization layer to normalize the feature vector, and a final layer to generate a prediction output from the normalized feature vector;
implement a global model based on the model definition, the global model having a set of global parameters;
perform one or more rounds of training by, for each round of training:
transmitting a set of global parameters to one or more selected clients of the one or more clients;
receiving information about a state of a respective local model from each respective one or more selected clients;
aggregating the received information into an aggregated update; and
updating the set of global parameters using the aggregated update; and
after training is terminated, transmit the updated set of global parameters from a last round of training as a set of trained global parameters to all of the one or more clients.

18. The computing system of claim 17, wherein the normalization layer is defined to normalize the feature vector by dividing the feature vector by a magnitude of the feature vector.

19. The computing system of claim 17, wherein the normalization layer is defined to normalize the feature vector by dividing the feature vector by a larger of:
a magnitude of the feature vector; or
a selected threshold value.

20. The computing system of claim 17, wherein the feature extraction subnetwork includes one or more convolutional layers or one or more long short-term memory (LSTM) layers.
